(19) United States
(12) Patent Application Publication
(10) Pub. No.: US 2014/0108684 A1
(43) Pub. Date: Apr. 17, 2014

(54) INTERCONNECT BANDWIDTH THROTTLER

(71) Applicants: Lance Hacking, Austin, TX (US); Ramana Rachakonda, Austin, TX (US); Belliappa Kuttanna, Austin, TX (US); Rajesh Patel, Austin, TX (US)

(72) Inventors: Lance Hacking, Austin, TX (US); Ramana Rachakonda, Austin, TX (US); Belliappa Kuttanna, Austin, TX (US); Rajesh Patel, Austin, TX (US)

(21) Appl. No.: 13/649,995

(22) Filed: Oct. 11, 2012

(51) Int. Cl. G06F 13/14

(52) U.S. Cl. 710/105

(57) ABSTRACT

An interconnect bandwidth throttler is disclosed. The interconnect bandwidth throttler turns off the interconnect, based on whether a maximum number of transactions has taken place within a predetermined throttle window. Both the maximum number of transactions and the throttle window are adjustable. Characteristics such as performance, thermal considerations, and average power are adjustable using the interconnect bandwidth throttler.

### CROSS-REFERENCE TO RELATED APPLICATIONS

This application claims priority to U.S. application Ser. No. 12/060,157, filed on Mar. 31, 2008 and issued as U.S. Pat. No. 8,050,177 on Nov. 1, 2011 and also claims priority to U.S. application Ser. No. 13/241,738, filed on Sep. 23, 2011 and issued as U.S. Pat. No. 8,289,850 on Oct. 16, 2012.

### TECHNICAL FIELD

This application relates to interconnect traffic in a central processing unit and, more particularly, to a mechanism for controlling interconnect traffic.

### BACKGROUND

Interconnect traffic between a central processing unit (CPU) and other circuitry of a system tends to occur in bursts. While it is common for the interconnect traffic to be fully utilized (e.g., at or close to 100%) for short periods of time, it is rare for the interconnect traffic to remain highly utilized for long periods of time. There may be opportunities to throttle, or turn off, the CPU when the CPU is not highly utilized.

### BRIEF DESCRIPTION OF THE DRAWINGS

The foregoing aspects and many of the attendant advantages of this document will become more readily appreciated as the same becomes better understood by reference to the following detailed description, when taken in conjunction with the accompanying drawings, wherein like reference numerals refer to like parts throughout the various views, unless otherwise specified.

FIG. 1 is a block diagram of an interconnect bandwidth throttler, implemented internal to a central processing unit, according to some embodiments;

FIG. 2 is a block diagram of an interconnect bandwidth throttler, implemented external to a central processing unit, according to some embodiments;

FIG. 3 is a block diagram of an interconnect bandwidth throttler, implemented to reduce interconnect bandwidth by throttling execution of one or more execution units, according to some embodiments;

FIG. 4 is a flow diagram showing operation of the interconnect bandwidth throttler of FIGS. 1, 2, or 3, according to some embodiments;

FIG. 5 is a graph showing typical interconnect traffic where no throttling occurs, according to some embodiments; and

FIG. 6 is a graph showing atypical interconnect traffic, including long periods of high interconnect bandwidth, according to some embodiments.

### DETAILED DESCRIPTION

In accordance with the embodiments described herein, an interconnect bandwidth throttler is disclosed. The interconnect bandwidth throttler turns off the interconnect based on whether a maximum number of transactions has take place within a predetermined throttle window. Both the maximum number of transactions and the throttle window are adjustable.

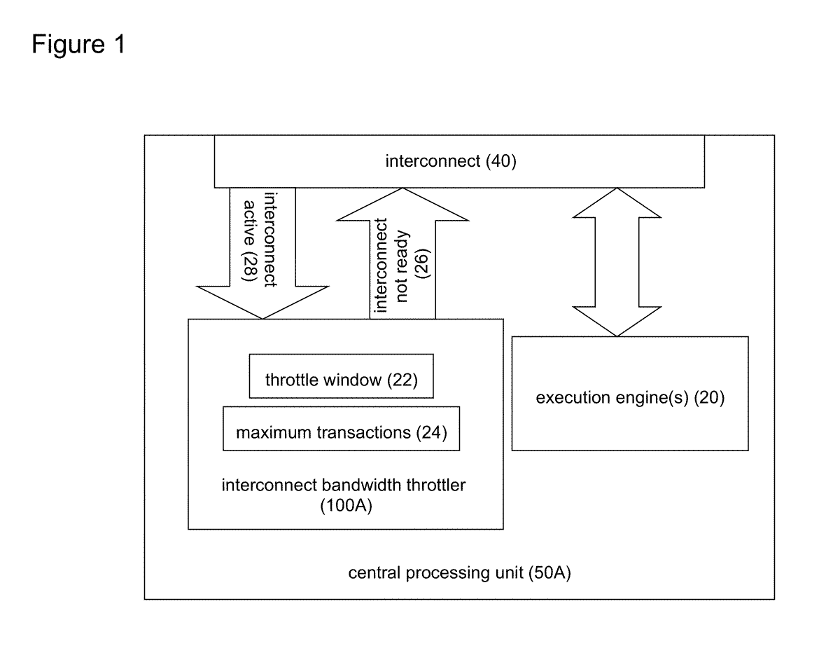

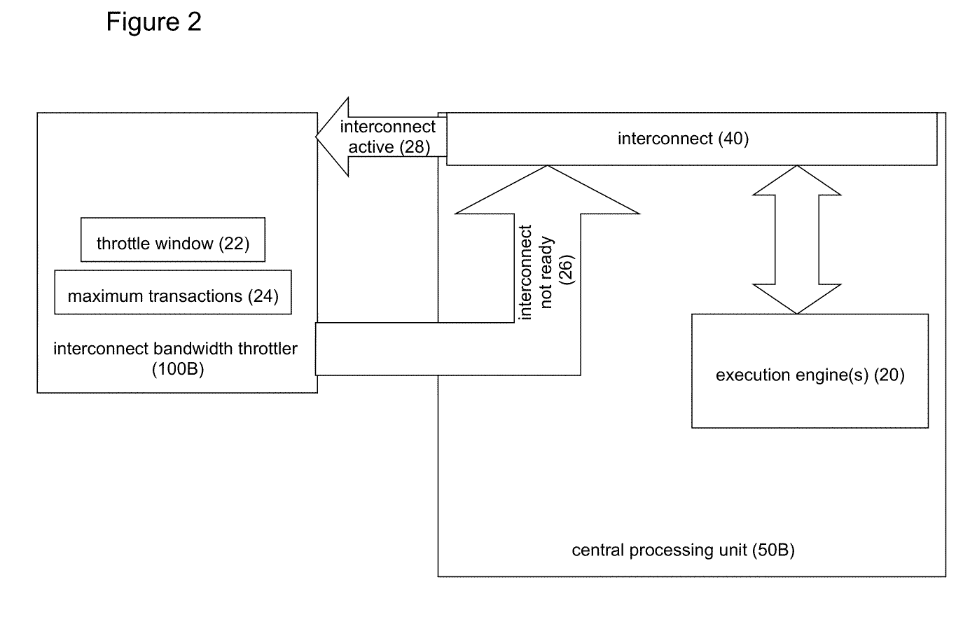

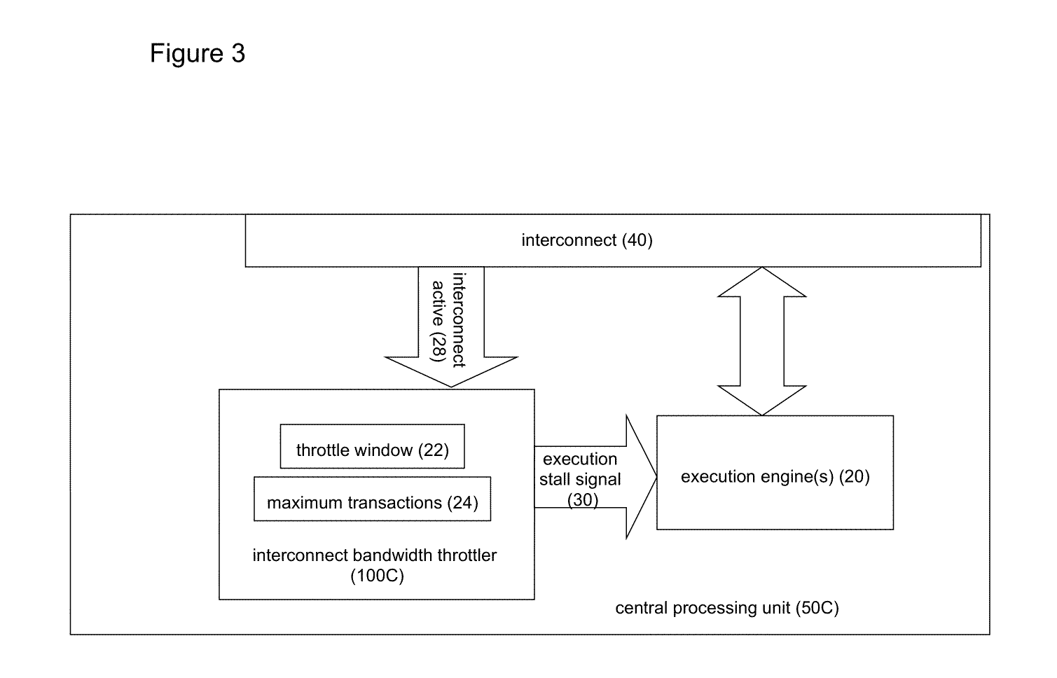

FIG. 1 is a block diagram of an interconnect bandwidth throttler 100A, implemented as part of a central processing unit (CPU) 50A, according to some embodiments. FIG. 2 is a block diagram of an interconnect bandwidth throttler 100B, implemented external to a CPU 50B, according to some embodiments. FIG. 3 is a block diagram of an interconnect bandwidth throttler 100C, operable on execution engine(s) within a CPU 50C, according to some embodiments.

Any of the above implementations are further referred to herein as an interconnect bandwidth throttler 100 of a CPU 50. The interconnect bandwidth throttler 100 caps the maximum traffic on the interconnect 40. The interconnect 40 connects the CPU 50 to other parts of a system. Accordingly, the interconnect 40 may be a bus, such as a front side bus, a data bus, an address bus, and so on. The interconnect bandwidth throttler 100 selectively allows access to the CPU 50 by enabling or disabling its interconnect 40 or indirectly reduces interconnect activity by throttling the rate of processing of one or more execution units with the CPU 50.

The interconnect bandwidth throttler 100 operates using two parameters, a throttle window parameter 22 and a maximum transactions parameter 24, in deciding when to generate a command 26 to the interconnect 40, shown in FIGS. 1 and 2 as “interconnect not ready”. The command 26 may be an execution stall signal (as in FIG. 3), a transaction, or a command. Where the interconnect 40 is a bus, for example, the command may be a “bus not ready” signal. The throttle window parameter 22 indicates a time period related to some indicator, such as a number of bus clocks. The maximum transactions parameter 24 indicates the number of allowed transactions within the throttle window from any agent on the interconnect 40.

In FIG. 3, the interconnect bandwidth throttler 100C sends an execution stall signal 28, not to the interconnect 40, but to one or more execution engines 20 that is connected to the interconnect. When the execution stall signal 28 is sent to an execution engine 20, the rate of processing may be reduced or stalled with the indirect effect of reducing interconnect utilization.

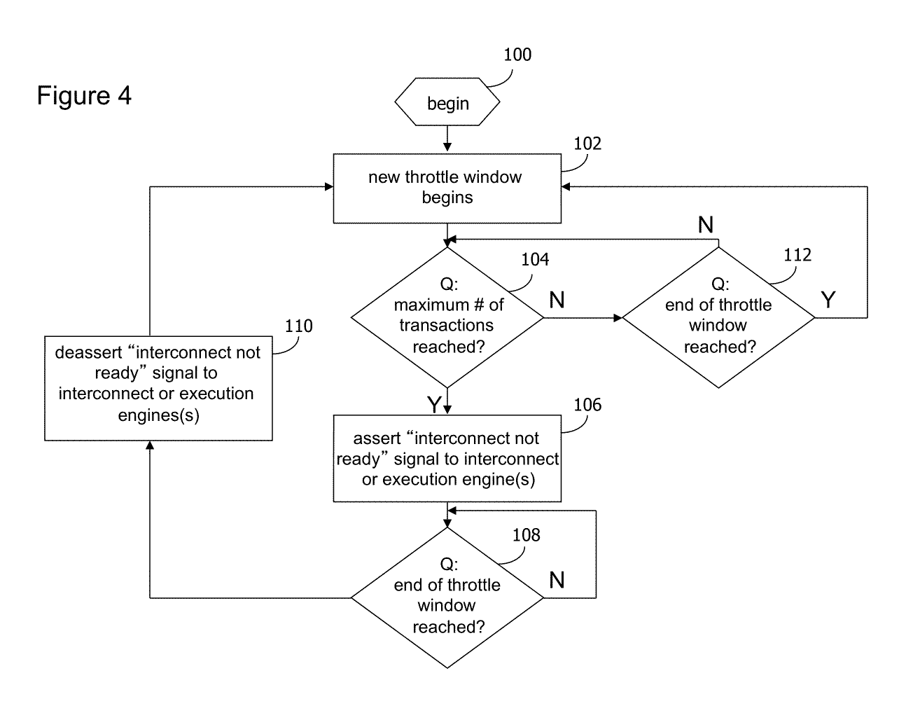

FIG. 4 is a flow diagram illustrating operations performed by the interconnect bandwidth throttler 100, according to some embodiments. At the commencement of a new throttle window (block 102), the interconnect 40 of the CPU 50 operates normally until a maximum number of transactions for the throttle window has been reached (block 104), as indicated by the maximum transactions parameter 24. In essence, the interconnect bandwidth throttler 100 is counting the transactions to the interconnect 40 during the throttle window.

While the maximum number of transactions has not been reached (the “no” prong of block 104), the transactions continue to be “counted” until the end of the current throttle window has been reached (block 112). Once the current throttle window ends, a new throttle window begins (block 102), and a new transaction count commences.

Once the maximum number of transactions has been reached, the interconnect bandwidth throttler 100 sends or asserts a command or a signal 26 (e.g., “interconnect not ready”) to the interconnect 40 (block 106). Once the command or signal 26 has been sent, the interconnect 40 is unavailable for transactions. Where the interconnect bandwidth throttler 100 controls an execution engine (FIG. 3), an execution stall signal 30 is sent to one or more engines, causing processing rate to slow or halt and interconnect utilization to be reduced.

Next, the interconnect bandwidth throttler 100 checks whether the end of the throttle window has been reached (block 108), as indicated by the throttle window parameter 22. Once the time period specified in the throttle window parameter 22 has been reached, the “bus not ready” signal 26 is disabled, or deasserted, to the interconnect 40 (block 110) and a new throttle window begins (block 102). The process is thus repeated for the new throttle window.

The interconnect bandwidth throttler 100 may be internal (FIG. 1) or external (FIGS. 2 or 3) to the CPU 50. The throttle window 22 and maximum transactions 24 parameters enable the throttle window size to be adjusted after the CPU 50 and throttler 100 are committed to silicon. Such adjustments may be desirable to account for performance, thermal considerations, and average power. Each of these characteristics is described below.

With respect to performance, interconnect traffic (traffic between the CPU and other circuitry of the system that use the interconnect 40) tends to occur in bursts. While it is common for the interconnect traffic to be fully utilized (e.g., at or close to 100%) for short periods of time, it is rare for the interconnect traffic to remain highly utilized for long periods of time. Thus, in some embodiments, the negative performance impact of the interconnect bandwidth throttler 100 may be reduced to a negligible amount in the vast majority of workloads by increasing the length (time) of the throttle window 22.

The temperature of an integrated circuit takes a long time to rise due to activity—generally, tens of seconds. Therefore, having a large throttle window 22 gives up very little in terms of capping the worst case thermal dissipation.

However, the average power (in terms of current/battery life, not heat) may be adversely impacted by a large throttle window 22 size. In some embodiments, any amount of throttling benefits the average power of the system.

Thus, the interconnect bandwidth throttler 100 takes advantage of these characteristics to reduce the average power and to reduce the maximum thermal dissipation of a system, with minimal impact to performance, in some embodiments. The interconnect bandwidth throttler 100 may further save battery life in the system, reduce cooling costs, and/or enable smaller form factors to be used.

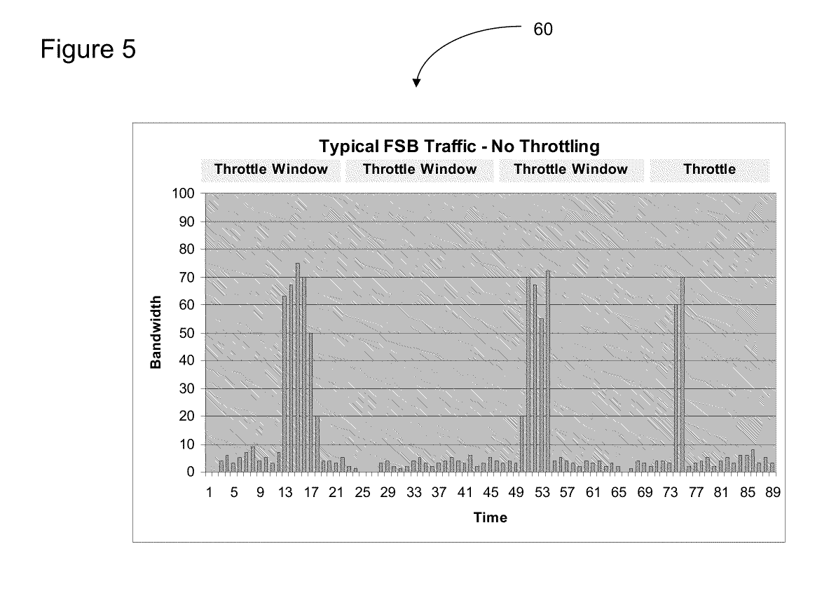

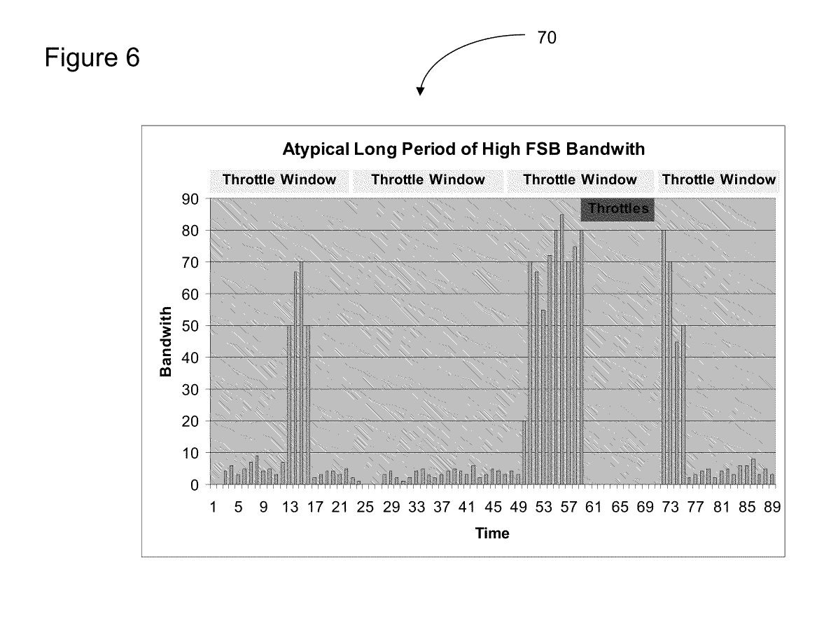

FIGS. 5 and 6 are graphs showing time versus bandwidth of an interconnect utilizing the interconnect bandwidth throttler 100, according to some embodiments. In each figure, four throttle windows are depicted. In the graph 60 (FIG. 5), there is some activity during the first, third, and fourth throttle window, with very little activity occurring during the second throttle window, with no throttle window having enough transaction activity to trigger the interconnect bandwidth throttler 100. In the graph 70 (FIG. 6), there is also more activity in the first, third, and fourth throttle windows, as compared to the second throttle window. This time, however, there is enough transaction activity in the third throttle window to cause the interconnect bandwidth throttler 100 to throttle the bus (e.g., send a “bus not ready” signal to the interconnect). During the throttle period, the graph 70 shows that there is no activity. At the start of the fourth throttle window, transaction activity resumes.

While the application has been described with respect to a limited number of embodiments, those skilled in the art will appreciate numerous modifications and variations therefrom. It is intended that the appended claims cover all such modifications and variations as fall within the true spirit and scope of the invention.

We claim:

1. An apparatus, comprising:
counting means to count a number of transactions executed by a central processing unit (CPU) during a throttle window time period;
processor operating means to cause the CPU to change from executing at a first operating speed to executing at a second operating speed;
signal means to issue a signal to an interconnect in response to the number of transactions exceeding a predetermined amount during the throttle window time period;
wherein the central processing unit operates at the second operating speed in response to the signal being received at the interconnect.

2. The apparatus of claim 1, wherein the throttle window time period is succeeded by a second throttle window time period, wherein:
the counting means restarts a count of the number of transactions executed by the CPU during the second throttle window time period; and
the signal means issues the signal to the interconnect in the second throttle window time period in response to the number of transactions exceeding the maximum number of transactions during the second throttle window time period.

3. The apparatus of claim 2, the CPU to operates using an average power;
wherein the average power is reduced when the signal is issued to the interconnect.

4. The apparatus of claim 1, wherein the signal to the interconnect is deasserted in response to completion of the throttle window time period.

5. The apparatus of claim 1, wherein the interconnect is a front side bus and the signal is a front side bus not ready signal.

6. The apparatus of claim 1, wherein the interconnect is a data bus and the signal is a data bus not ready signal.

7. The apparatus of claim 1, wherein the interconnect is an address bus and the signal is an address bus not ready signal.

8. The apparatus of claim 1, wherein the counting means and signal means are within the CPU.

9. The apparatus of claim 1, wherein the counting means and the signal means are external to the CPU.

10. A non-transitory computer-readable medium including code, when executed, to cause a machine to perform the operations of:
counting transactions issued on an interconnect bus in during a throttle window time period, the throttle window time period comprising a start and an end, wherein the interconnect bus couples a central processing unit to circuitry of a system;
asserting a signal in response to the transaction count exceeding a maximum value during the throttle window time period;
deasserting the signal in response to the end of the throttle window time period;
wherein the central processing unit operates at a first performance rate in response to the signal being asserted and operates at a second performance rate in response to the signal being deasserted.

11. The non-transitory computer-readable medium including code of claim 1, which further, when executed, causes the machine to perform the operations of:
asserting the signal to the interconnect bus in response to the transaction count exceeding the maximum value during the throttle window time period; and
deasserting the signal to the interconnect bus in response to the end of the throttle window time period.

12. The non-transitory computer-readable medium including code of claim 1, which further, when executed, causes the machine to perform the operations of:
asserting the signal to an execution in response to the transaction count exceeding the maximum value during the throttle window time period, wherein the execution engine couples the central processing unit to an interconnect; and deasserting the signal to the execution engine in response to the end of the throttle window time period.

13. The non-transitory computer-readable medium including code of claim 1, which further, when executed, causes the machine to perform the operations of:
adjusting the throttle window time period from a first time period to a second time period.

14. The non-transitory computer-readable medium including code of claim 1, which further, when executed, causes the machine to perform the operations of:
adjusting the transaction count from a first count value to a second count value.
